(19) United States
(12) Patent Application Publication
(10) Pub. No.: US 2007/0094411 A1
(43) Pub. Date: Apr. 26, 2007

(54) Network communications system and method

(76) Inventors: Mark Mullane, Blackrock (IE); Thomas Maher, Dublin (IE)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 11/364,746

(22) Filed: Feb. 28, 2006

(30) Foreign Application Priority Data
Aug. 4, 2005 (IE) S2005/0519

(51) Int. Cl. G06F 15/16

(52) U.S. Cl. 709/245

(57) ABSTRACT

A network communications system and method are disclosed. The system and method allow clients that are connected to separate networks interconnected using network address translation (NAT) to resolve names without the need to implement a split DNS system. The method provides for performing name resolution in a computer network, the network comprising one or more clients that communicate with hosts external to the network using network address translation. The method comprises: identifying traffic in the network that contain DNS messages, identifying DNS messages to be modified based on a network address translation table, and modifying a source or a destination address in identified DNS messages based on the network address translation table.

### BACKGROUND OF THE INVENTION

1. Field of the Invention

This invention relates to a system and a method for communication in a computer network.

2. Background of the Art

Most of the abbreviations used in this specification will be familiar to those skilled in the technical field, so their definitions will not be placed into the body of the text; however, a glossary is provided at the end of the description.

The present applicant has previously proposed a networking system in which clients in a client access network connect to servers in a private network. A limitation of that system is that servers in the private network must be assigned addresses from a private routing realm. This introduces a requirement to employ Destination Network Address Translation (DNAT) schemes, which, in known schemes, implies the use of a split DNS infrastructure to enable clients in the private routing realm to resolve domain names of servers to the server's translated IP addresses. While the previous system works well in many applications, there are situations in which a split DNS infrastructure can be inconvenient or inoperable.

### SUMMARY OF THE INVENTION

An aim of the invention is to enable server addresses to be mapped to translated IP addresses and for a client's DNS query and/or response to be modified to reflect the server's translated IP address, thereby removing the requirement for a split DNS infrastructure.

When a router, gateway or proxy separates networks with different routing realms, NAT is used to translate addresses from one routing realm to another. Typically, network clients use DNS to resolve the IP address of servers that they need to connect to. When a server is accessible from more than one routing realm, a DNS is maintained for each routing realm to resolve the addresses of servers for clients within each routing realm. This solution is commonly known as a split DNS. Creating a split DNS requires the creation, configuration, deployment and management of an additional DNS infrastructure and requires ongoing time and resources.

A DNAT system that enables clients in a first routing realm to resolve domain names of servers in a second routing realm to the server translated addresses in the first routing realm by automatically filtering DNS messages based on the address translation table would remove the cost associated in deploying a split DNS infrastructure.

The present invention discloses a method of DNAT with an integrated DNS filter which modifies DNS messages according to the network address translation table.

The only configuration information required by the DNS filter is the network address translation table. In particular, configuration of the DNS filter requires no DNS zone information, as specified in IETF RFC 1034 “Domain Names—Concepts and Facilities”, P. Mockapetris, November 1987.

The DNAT function passes DNS messages to the DNS filter, where the message is inspected. The DNS filter modifies, based on the method disclosed, DNS messages based on the network address translation table.

The preferred embodiment of the DNAT with integrated DNS filter is as part of a component of a secure communication system.

The invention relates to a destination network address translation (DNAT) system for mapping host IP addresses to assigned translated IP addresses, in combination with a DNS filter which automatically modifies DNS messages according to the DNAT translation table in operation.

From a first aspect, this invention provides a method of performing name resolution in a computer network, the network comprising one or more clients that communicate with hosts external to the network using network address translation, the method comprising:
a) identifying traffic in the network that contains DNS messages;
b) identifying DNS messages to be modified based on a network address translation table, and
c) modifying a source or a destination address in identified DNS messages based on the network address translation system's translation table.

Thus, in embodiments of the invention, DNS data is translated in a manner similar to the translation applied to packets during the performance of network address translation, such that DNS operations become transparent to clients on the network.

After modification, the modified DNS messages typically replace the identified DNS messages. This makes operation of the method transparent to the clients.

To be effective, only DNS messages of CLASS=IN and with resource records of type=PTR or type=A are, in typical embodiments, identified as being for modification. When an identified DNS message contains a host address, the host address may be modified by changing it to a translated address derived from the network address translation table. For example, the DNS message may be type A as defined in IETF RFC 1034. In such cases where the DNS message being an incoming message to a DNS server of the network, the address in any type A record in the message is typically matched against translated addresses in the translation table and replaced by a corresponding real address. Alternatively, where the DNS message is an outgoing message from a DNS server of the network, the address in any type A record in the message is typically matched against real addresses in the translation table and replaced by a corresponding translated address.

When an identified DNS message of type PTR contains a pointer to another part of a domain namespace, the pointer may be modified by changing subdomain names, the modified subdomain being derived from the network address translation table. For example, where the DNS message is type PTR and the modified subdomain is a subdomain of IN-ADDR.ARPA. In cases where the DNS message is an incoming message to a DNS server of the network, the address in the subdomain in any PTR record of the message is typically matched against translated addresses in the translation table and the modified subdomain is a corresponding real address. Alternatively, where the DNS message is an outgoing.message from a DNS server of the network, the address in the subdomain in any PTR record in the message is typically matched against real addresses in the translation table and the modified subdomain is a corresponding translated address.

From a second aspect, this invention provides a network communication device comprising a DNS filter operative to filter packets on a computer network in order to perform a method according to the first aspect of the invention.

Such a network communication device may be further operable as a network router or a network proxy. In addition, it may be further operable as a network address translation gateway. Typically, the DNS filter is implemented as a software component.

### BRIEF DESCRIPTION OF THE DRAWINGS

An embodiment of the invention will now be described in detail, by way of example, and with reference to the accompanying drawings, in which:

FIG. 1 is a block diagram of a remote client accessing a private network via a transparent proxy implemented as an agent and broker over the Internet;

FIG. 2 depicts a network address translation table; and

FIG. 3 shows the DNS filter process flow.

### DETAILED DESCRIPTION

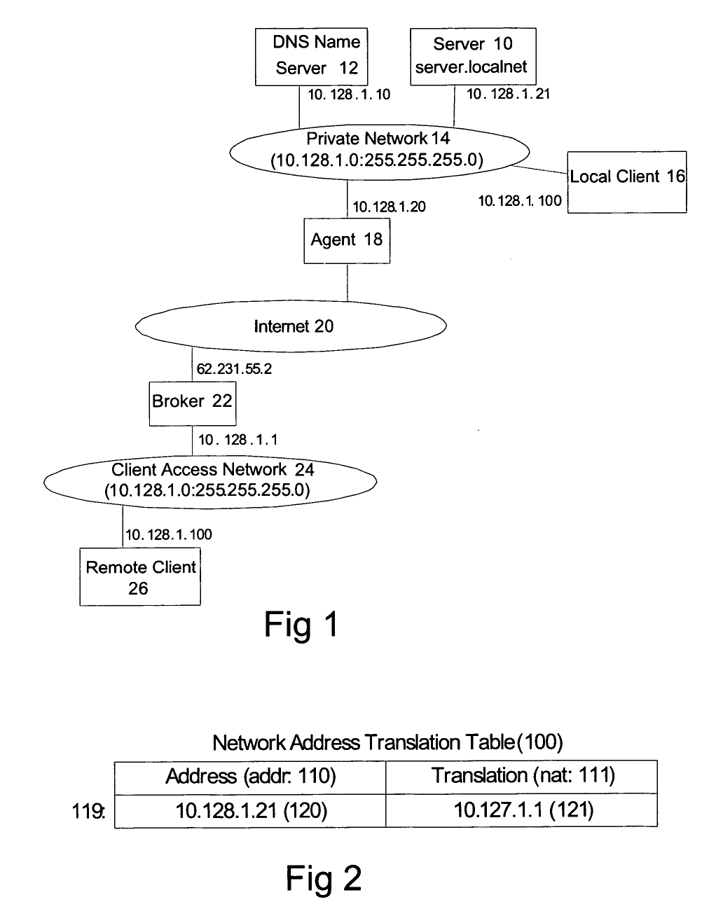

FIG. 1 shows a private network 14 with a DNS name server 12 and a server 10. The DNS Name Server 12 has a DNS “A” resource record for server 10 with domain name “server.localnet” mapped to IP address “10.128.1.21” and a DNS “PTR” resource record for the server 10 with IP address “10.128.1.21” (21.1.128.10.IN-ADDR.ARPA) mapped to the domain name “server.localnet”.

The local client 16 can communicate directly with the DNS name server 12 and the server 10. A DNS resolver on the local client 16 is configured with a DNS name server IP address 10.128.1.10, the IP address of the DNS name server 12. Software on local client 16 is configured to connect to the server 10 by referring to the server 10 as domain name “server.localnet”.

Connections from the local client 16 to the server 10 using the domain name “server.localnet” are typically preceded by a DNS revolver query to resolve domain name “server.localnet” to an IP address. The DNS resolver on the local client 16 sends a DNS request message to the DNS name server 12 asking for the “A” resource record for “server.localnet”. The DNS name server 12, after consulting its zone information, returns the DNS response with the “A” resource record for “server.localnet” containing the IP address “10.128.1.21”. The DNS resolver on the local client 16 returns the IP address “10.128.1.10” in answer to the DNS “A” query for “server.localnet” and the software then connects to server 10 directly on the private network 14.

FIG. 1 also shows a remote client access scenario with a remote client 26, on a client access network 24. A broker 22 on the client access network 24 enables secure communications with private networks through intermediate hosts or routers, shown for example at 18, over an insecure network, for example the Internet 20, using a secure communication system.

The broker 22 can route data to the DNS name server 12 through the agent 18 using service-based routing. The remote client 26 is configured with the broker gateway address (10.128.1.1) which serves as a gateway to the address of the DNS name server 12.

DNS queries from the remote client 26 are sent to the broker 22 gateway address (10.128.1.1), where they are identified as DNS messages by their application layer destination identifier (UDP/TCP port 53). The broker 22 transparently proxies the DNS message to the agent 18, where the agent 18, sends the DNS message on behalf of the remote client 26 to the DNS name server 12 using service-based routing. The DNS message is sent from the agent 18 (source IP address 10.128.1.20) to the DNS name server 12 (destination IP address 10.128.1.10). Service-based routing therefore enables remote clients, exemplified by the remote client 26, to transparently communicate with DNS Name Servers, for example 12 on the private network, for example 14.

However, the private network 14 has an IP address 10.128.1.0 with subnet mask 255.255.255.0, which is identical to the IP address of the client access network 24. Therefore, the remote client 26 cannot communicate by destination address routing with hosts on the private network 14. For example, the remote client 26 cannot communicate with the server 10 having IP address 10.128.1.21.

To solve the routing problem between the remote client 26 on the client access network 24 and the server 10 on the private network 14, the agent 18 employs destination network address translation (DNAT). The destination network address translation table 100, depicted in FIG. 2, is defined on the agent 18. The destination network address translation table 100 defines the mapping between addresses (addr:110) within the agent's 18 routing realm, and address translations (nat:111) for use within the client access network's 24 routing realm.

For each entry in the destination address translation table 100, the broker 22 has a route for the translated address (nat:111) address via the agent 18. The remote client 26 can therefore communicate with the server 10 using the translation address 10.127.1.1 (120). The broker 22 routes connections to 10.127.1.1 by destination address routing through the agent 18. The agent 18 looks-up the destination IP address 10.127.1.1 in the network address translation table 100 and finds a matching translation (nat:111) at row 119 upon which the agent 18 translates the destination address to address (addr:110) 10.128.1.1.21 (120); the real address ofthe server 10.

The introduction of the destination network address translation by prior art methods, introduces the requirement for a split DNS if clients in front of the DNAT are to use domain name resolution to resolve server IP addresses behind the DNAT. In contrast, methods embodying the invention provide a DNS message filtering algorithm, integrated with the destination NAT function, to inspect and modify DNS messages to reflect the rules in the network address translation table 100.

In the preferred embodiment, all DNS data passing through the agent 18, both inbound (from broker 22 to private network 14) and outbound (from private network 14 to broker 22) are passed to the DNS filter. The DNS filter determines whether DNS messages are to be modified or forwarded unaltered. The role of the filter is to apply the rules of the network address translation table 100. To do this, it must replace all inbound (that is, from the client 26 to the DNS name server 12) references to a translated address 111 with the corresponding real addresses 110, and replace all outbound (that is, from the DNS name server 12 to the client 26) references to a real address 110 with the corresponding translated address 111. DNS information is held in resource records (RR). IP Address information in DNS is primarily held and communicated in “Type=A” RRs, but also in “Type=PTR” RRs for the IN-ADDR.ARPA domain as specified in IETF RFC 1035 “Domain Names—Implementation and Specification”, P. Mockapetris, November 1987. The filter modifies these resource records in each DNS message, as well as potentially modifying DNS questions for translated addresses, such as PTR (reverse-lookup) queries. The filter is stateless and requires no configuration other than the address translation table 100.

For example, the remote client 26, when communicating by domain name with “server.localnet” (the server 10), will begin by first attempting to resolve domain name “server.localnet” to an IP address. The remote client 26 does this by sending a DNS message to its DNS name server 12, the broker 22 gateway address 10.128.1.1, with a DNS request query containing the question “Name=server.localnet., Type=A, Class=IN”. The DNS message is routed, based on service, to the agent 18 through the broker 22.

The agent 18 passes the inbound DNS request message to the DNS filter where, in this case, the DNS message is unaltered. The unaltered DNS message is then proxied, based on service, to the DNS name server 12.

The DNS name server 12 responds to the agent 18 with the DNS response message containing the resource record for “server.localnet”, which (for example) might be “server.localnet 86400 IN A 10.128.1.21”.

The agent 18 passes the outbound DNS response message to the DNS filter. The DNS filter searches the network address translation table 100 for a row with an address (addr:110) matching the resource record IP address 10.128.1.21, finding the matching row 119. The DNS filter, having found a match, modifies the DNS message by changing IP address 10.128.1.21 in the resource record to IP address 10.127.1.1 (121) corresponding to the translation (nat:111) in the row 19. The DNS filter returns the modified DNS message.

The modified DNS message, having the modified resource record “server.localnet 86400 IN A 10.127.1.1”, is routed back to the remote client 26 where the domain name “server.localnet” is resolved to translated address 10.127.1.1, which remote client 26 can use to communicate with server 10 from client access network 24.

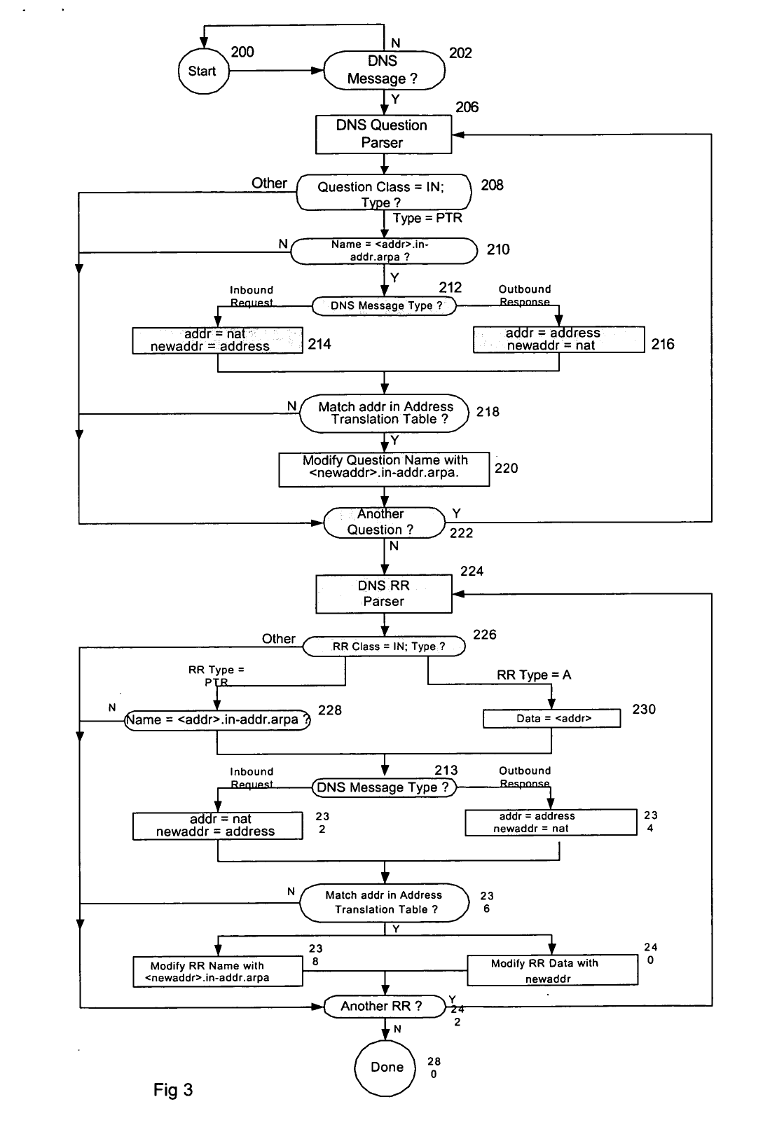

The DNS filter implements an algorithm to inspect and modify DNS messages. The algorithm is now described with the help of the process flow diagram in FIG. 3 and reference to IETF RFC 1035 “Domain Names - Implementation and Specification”, P. Mockapetris, November 1987.

When DNS messages pass through the network address translation system, they are passed to the DNS filter, along with a flag to indicate the direction of flow (inbound/outbound). The DNS filter process starts 200 on a decision point 202 to determine if there is a valid DNS message. If not, the DNS filter waits for a valid DNS message. If, on the other hand there is a DNS message, the message type is saved for use later at decision points 212 and 213. Next, a DNS question parser 206 iterates and parses through all question sections in the DNS message. If the question CLASS is not IN, and the type is not PTR, then this question is unaltered and the parser proceeds to the next question (if any) 222. Otherwise, the parser checks if the question “name” is in the “IN-ADDR.ARPA” domain 210. If not, then this question is unaltered. If so, then the address is extracted and checked against the address translation table 100.

The lookup for a match 218 against the address translation table 100 is based on the nature of the DNS message. If the message is an inbound request 214 (from the client 26 to name server 12), then the match is on the translation address 111 and the returned “newaddr” (if any) is a real address (addr:110). If the message is an outbound response 216 (from the name server 12 to the client 26), then the match is on the real address 110 and the returned “newaddr” (if any) is a translated address (nat:111). In any case, if a match is found, the question name is modified 220 with “newaddr”. If there is no match, the question is unaltered. Processing continues 222 until all questions in the question section of the DNS message have been processed.

Next, a DNS RR parser 224 parses and iterates through each RR and determines the CLASS and TYPE (226). The only RRs which require filtering are CLASS=IN RRs of TYPE=PTR or TYPE=A. All others are unaltered 242. The name of a PTR RR is checked to see if the name is in the “IN-ADDR.ARPA” domain and the address extracted for matching if so 228. The ADDRESS in the DATA section of a type A RR is extracted for matching 230.

The lookup for a match 236 against the address translation table 100 is based on the nature of the DNS message. If the message is an inbound request 232 (from the client 26 to the DNS name server 12), then the match is on the translation address (nat:111) and the returned “newaddr” (if any) is a real address (addr:110). If the message is an outbound response 234 (from the name server 12 to the client 26), then the match is on the real address (addr:110) and the returned “newaddr” (if any) is a translated address (nat:111). If there is a match for a type A RR, the A data is modified with “newaddr”. If there is a match for a type PTR RR, the name is modified with “newaddr”. If there is no match the RR is unaltered. In any case, processing continues 242 until all RRs are processed 280.

When done at 280, the DNS message is passed back to the DNAT finction (the agent 18 in the preferred embodiment) for routing as normal.

Definitions and abbreviations used in this specification, together with references to relevant Internet Engineering Task Force (IETF) documents are set forth below. These documents are familiar to and readily available to those skilled in the technical field.
Network Address Translation (NAT): Translation of network addresses and other higher-layer identifiers (such as UDP port) and related fields (such as checksum) in a datagram as a datagram traverses from one routing realm to another. NAT is defined in IETF RFC 1631 “The IP Network Address Translator (NAT)”, K. Egevang, et al., May 1994.
Destination NAT (DNAT): Destination NAT is a specific form of NAT where the server-side (destination) address is the subject of translation, as distinct from the more common client-side (source) address to support hosts on private networks which communicate through a NAT router with hosts on the Internet.
Hosts: PCs or other network devices connected to a network. Many network-based services are delivered in a client-server model, where client hosts “connect” to server hosts, and server host “listens” for connections from client hosts.
Router: An intelligent network device capable of forwarding received packets to another network. Routing may be host-based on the packet destination and/or source, or based on routing tables or other configuration data.
Routing Realm: Hosts on an IP network are assigned unique IP addresses. However, to enable the Internet to grow beyond the limits of the 32-bit IPv4 address space, a mechanism to share IP addresses is required. A routing realm defines the set of hosts and routers that share the same information about how to reach all addressed hosts.
Destination Address Routing: A routing scheme used by routers where the routing decision is made by looking up the destination address of the received packets against a routing table. This is the most common routing schema.
Service-Based Routing: A routing scheme used by routers where the routing decision is based on application layer identifiers in a packet (e.g., port number).
Split DNS: A split DNS infrastructure is a solution to the problem of using the same domain name for resources that are accessible from two different routing realms. Clients located internally in one routing realm resolve domain names from an internal DNS and clients located externally in another routing realm resolve the same domain names from an external DNS.
Virtual Private Network: A private network constructed across a public network, such as the Internet. There are two main types of VPN—remote access and leased-line replacement. In the remote access scenarios, client's “dial-up” over secure tunnels to an access server, also known as a security gateway, which provides private network connectivity.
DNS: Domain Name System (EETF RFC 1034 “Domain Names—Concepts and Facilities”, P. Mockapetris, November 1987 and IETF RFC 1035 “Domain Names—Implementation and Specification”, P. Mockapetris, November 1987).
NAT: Network Address Translation (IETF RFC 1631 “The IP Network Address Translator (NAT)”, K. Egevang, et al., May 1994).
DNAT: Destination Network Address Translation.
TCP: Transmission Control Protocol (IETF RFC 793 “Transmission Control Protocol, DARPA Internet Program, Protocol Specification”, September 1981).
UDP: User Datagram Protocol (IETF RFC 1034 “Domain Names—Concepts and Facilities”, P. Mockapetris, November 1987).
VPN: Virtual Private Network
RR: Resource Record (IETF RFC 1035 “Domain Names—Implementation and Specification”, P. Mockapetris, November 1987).

What is claimed is:

1. A method of performing name resolution in a computer network, the network comprising one or more clients that communicate with hosts external to the network using network address translation, the method comprising:
a) identifying traffic in the network that contain DNS messages;
b) identifying DNS messages to be modified based on a network address translation table, and
c) modifying a source or a destination address in identified DNS messages based on the network address translation table.

2. A method according to claim 1 in which the modified DNS messages replace the identified DNS messages.

3. A method according to claim 1 in which only DNS messages of CLASS=IN and with resource records of TYPE=PTR or TYPE=A are identified as being for modification.

4. A method according to claim 1 in which, when an identified DNS message contains a host address, the host address is modified by changing it to a translated address derived from the network address translation table.

5. A method according to claim 4 in which the DNS message is of type A as defined in IETF RFC 1034.

6. A method according to claim 4, the DNS message being an incoming message to a DNS server of the network, in which the address in any type A record in the message is matched against translated addresses in the translation table and replaced by a corresponding real address.

7. A method according to claim 4, the DNS message being an outgoing message from a DNS server of the network, in which the address in any type A record in the message is matched against real addresses in the translation table and replaced by a corresponding translated address.

8. A method according to claim 1 in which, when an identified DNS message of type PTR contains a pointer to another part of a domain namespace, the pointer is modified by changing subdomain names, the modified subdomain being derived from the network address translation table.

9. A method according to claim 8 in which the DNS message is of type PTR and the modified subdomain is a subdomain of IN-ADDR.ARPA.

10. A method according to claim 9 in which the DNS message is an incoming message to a DNS server of the network, in which the address in the subdomain in any PTR record of the message is matched against translated addresses in the translation table and the modified subdomain is a corresponding real address.

11. A method according to claim 9 in which the DNS message is an outgoing message from a DNS server of the network, in which the address in the subdomain in any PTR record of the message is matched against real addresses in the translation table and the modified subdomain is a corresponding translated address.

12. A network communication device comprising a DNS filter operative to filter packets on a computer network in order to perform a method according to claim 1.

13. A network communication device according to claim 12 which is operable as a network router or a network proxy.

14. A network communication device according to claim 12 which is operable as a network address translation gateway.

15. A network communication device according to claim 12 in which the DNS filter is implemented as a software component.
